(19) United States
(12) Patent Application Publication
(10) Pub. No.: US 2024/0159911 A1
(43) Pub. Date: May 16, 2024

(54) Establishing Resilient PNT in Railroad Infrastructure

(71) Applicant: Meteorcomm, LLC, Renton, WA (US)

(72) Inventor: Derek Edmondson, Tacoma, WA (US)

(21) Appl. No.: 18/508,033

(22) Filed: Nov. 13, 2023

Related U.S. Application Data
(60) Provisional application No. 63/424,800, filed on Nov. 11, 2022.

(51) Int. Cl. G01S 19/21; B61L 25/02; G01S 19/50

(52) U.S. Cl. CPC G01S 19/215; B61L 25/025; G01S 19/50; B61L 2205/04

(57) ABSTRACT

Methods and apparatus for detecting of spoofing or jamming activities near a train or other railroad assets uses a message sent from each of a plurality of base stations receiving a wireless packet transmitted by a radio of a railroad asset that reports the PNT information determined by the radio using GNSS and a timestamp for the time of arrival of wireless packet at the base station. The position of the asset is then calculated based on the time arrival of the wireless packet at each base station and compared to the reported position. A warning is generated if the difference exceeds a predetermined threshold.

### RELATED APPLICATIONS

This application claims the benefit of U.S. provisional application No. 63/424,800, filed Nov. 11, 2022, which is incorporated herein by reference in its entirety for all purposes.

### BACKGROUND

The Disclosure relates to railroad infrastructure used for positive train control (PTC).

The Class I freight railroads in the United States formed PTC-220 LLC to secure the 220 MHz spectrum as a data radio infrastructure to carry PTC data between base stations, wayside, and mobile units. Interoperable transports allow direct communications between the remote asset of one railroad (for example, a locomotive) and a back office of another railroad.

The nationwide interoperable wireless transport network in the United States for train control applications and other railroad applications in the 220 MHz spectrum reserved for train control is called ITCnet®, which was developed by Meteorcomm, LLC of Renton, Washington. ITCnet® is currently capable of, for example, transporting messages for CTC (Centralized Traffic Control), IPC, IPTC (Interoperable Positive Train Control), and other systems used by railways in North America. It also allows for mobile, wayside, and base station radios to communicate over narrowband channels in the 220 MHz band.

The protocols used for ITCnet, including the Interoperable Train Control Radio (ITCR) standard, support interoperable PTC functions within the available spectrum of 220 MHz. The ITCR standard and U.S. Pat. Nos. 8,340,056, 8,602,574, and 10,710,620, which are incorporated herein by reference for all purposes, disclose and describe various aspects of communication processes relating to the ITCnet® radio network. The ITCR standard specifies a common air interface that focuses on the communications aspects of the PTC system in a 220 MHz band, including operations in the network, link, and physical layers, for transport of PTC messages between base stations and train locomotives using RF links specified by the ITCR standard.

ITCnet radio network supports a messaging service for railroad applications that conforms to a published standard called Interoperable Train Control Messaging (ITCM). The ITCM messaging service allows PTC and other railroad applications to exchange messages between application endpoints over any type of connection or transport, regardless of location. ITCM messages may also be transported by Wi-Fi networks using the ITC Interoperable IEEE (Institute of Electrical and Electronics Engineers) 802.11 Network Transport protocol and non-interoperable transports. Examples of such non-interoperable networks include cellular, satellite, other types of mobile wireless networks, and packet-switched computer networks that use Internet Protocol (IP) for routing (“IP networks”) between endpoint hosts.

Many railroad applications for PTC, centralized traffic control (CTC), infrastructure fault monitoring, locomotive trip optimization, and protection of maintenance workers on or near the tracks, as well various business applications related to the transportation of freight and passengers, rely on position, navigation, and timing (PNT) information. Proper operation of these railroad applications relies on the availability of accurate position, navigation, and time (PNT) services to railroad assets such as locomotives, end of train units, and waysides.

As explained in Executive Order 13905 of Feb. 12, 2020, 85 Federal Register 32 (Feb. 18, 2020), there is widespread concern that PNT services used by critical infrastructure, including transportation infrastructure such as train control networks, are subject to attack. PNT services often rely on global satellite navigation systems (GNSS), which are vulnerable to spoofing and jamming due to the availability of low-cost technology and published instructions the enable these exploits.

### SUMMARY

Disclosed below are methods and apparatus for adapting railroad infrastructure to make PNT services used by railroad assets more resilient to spoofing, jamming, and similar attacks.

In one representative, nonlimiting examples of a method, a train control network provides a reference position and a reference time. The reference position and time are used to validate the position and time determined by a railroad asset using GNSS, thus increasing the confidence of a position and time determination made by the railroad asset. A difference that exceeds a predetermined threshold between the reference time or position and the time and position reported by an asset indicates the possibility of, for example, spoofing and jamming activities near the railroad asset and can be used, for example, to generate a warning or for other uses.

### BRIEF DESCRIPTION OF THE DRAWINGS

FIG. 1 illustrates an interoperable train control wireless network and time delay associated with different base stations in the network and a railroad asset with a spoofed location.

FIG. 2 schematically represents some of the communication and navigation system components of base stations of interoperable train control wireless network and railroad assets with radios that operate on the interoperable wireless train control network.

FIGS. 3A, 3B, and 3C are flow diagrams representing processes at a railroad asset, a base station, and a server, respectively, for detecting and reporting attempts to interfere with position, navigation, and time systems used by railroad assets for train control and other railroad operations.

### DETAILED DESCRIPTION

In the following description, like numbers refer to like elements. However, the user of the same reference for like elements does not imply or require that they be identical elements or the same element.

For purposes of the following description, the following terms will generally have the meanings given below unless the context indicates otherwise.

An “asset” or “railroad asset” refers to any railroad asset, such as a locomotive, a wayside, a “HyRail” ® equipped vehicle, or any other type of PNT-aware equipment equipped with a remote radio that is used to communicate with a wireless train control network.

An ITCnet radio is a radio that is capable of transmitting and receiving on the ITCnet network or a wireless network that implements the ITCR protocols, future versions of these protocols, and successor protocols. An ITCnet radio is a representative example of a radio for transmitting and receiving packets over wireless segments of an interoperable train control network. ITCnet is a representative, non-limiting example of such a network. An “ITCnet base radio” is an ITCnet radio that operates as a base station. An “ITCnet asset radio” is an ITCnet radio is a remote radio that is on-board a mobile or moving asset or that is located with a fixed position asset that services the asset.

An “ITCRPNT packet” is a wireless data packet transmitted by an ITCnet asset radio that contains PNT related information as determined by the asset. PNT information includes one or more of the following as determined by the asset: position information, navigation (heading and speed) information, and time information (for example, UTC time and date). An ITCRPNT packet is a representative example of what will be referred to as a resilient PNT packet or a PNT validation packet that is used by an application or service of a wireless train control network like ITCnet to detect whether the asset's determination of its location, time, and/or navigation parameters is being spoofed. In embodiments described below, the application generally will be referred to as RPNT, and the processes that determine with the asset being spoofed are referred to as a “TLA Time-Location Agent,” and it runs on a server called the “RPNT Server.”

A “captive GNSS sensor” is any global navigation satellite system (GNSS) sensor that is either on-board a moving asset or co-located at a fixed location asset. An “integrated GNSS sensor” is a captive GNSS sensor integrated into the asset's remote radio.

A “captive LAN” is a local area network (LAN) that interconnects devices locally to the equipment either on-board a moving asset or co-located at a fixed asset's location. This does not include any interconnected equipment that is not either on-board a moving asset or co-located at the location of the fixed asset.

A “participating base” is a base station radio that receives an ITCRPNT packet. A “non-participating bases are ITCnet Base Radios determined to be far enough away to be out of range of or beyond the radius of influence of a spoofing attack.

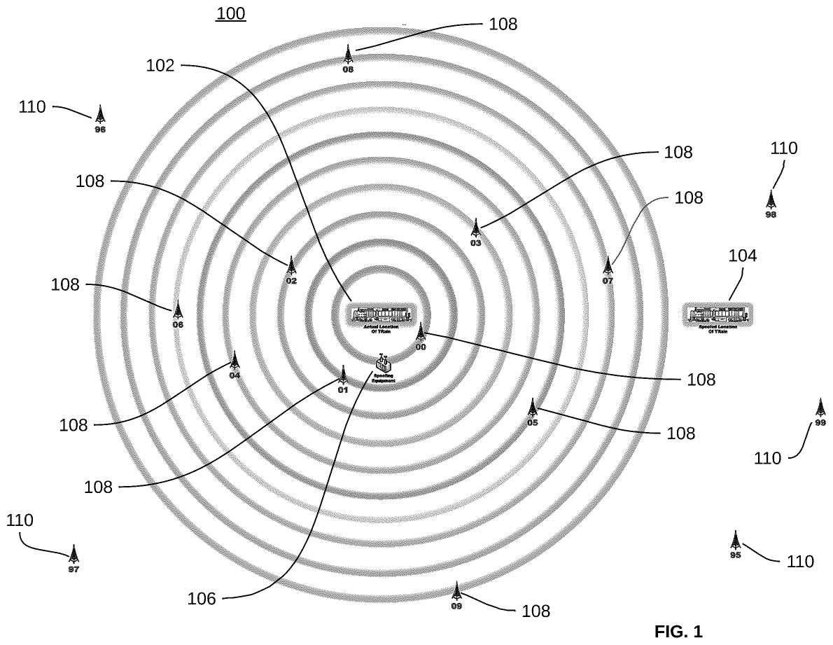

FIG. 1 is a diagram that is a geographic representation of a wireless train control network 100 that is spread over a geographic. A railroad asset in the form of train 102 is in the center of the figure. The wireless train control network 100 is a radio network that provides wireless transport services for interoperable train control applications and other railroad applications that require reliable communication between client applications operating on remote railroad assets and server applications hosted in “central offices” or “back offices” of railroads and various operators and service providers. An example of such a network is the nationwide ITCnet network that comprises multiple “participating” base stations 108 and multiple “non-participating” base stations 110. The concentric rings surrounding train 102 represent distances between the actual position of train 102 and the base stations 108. Spoofing equipment 106 is attacking the PNT services of the network to make the train appear to be at spoofed location 104.

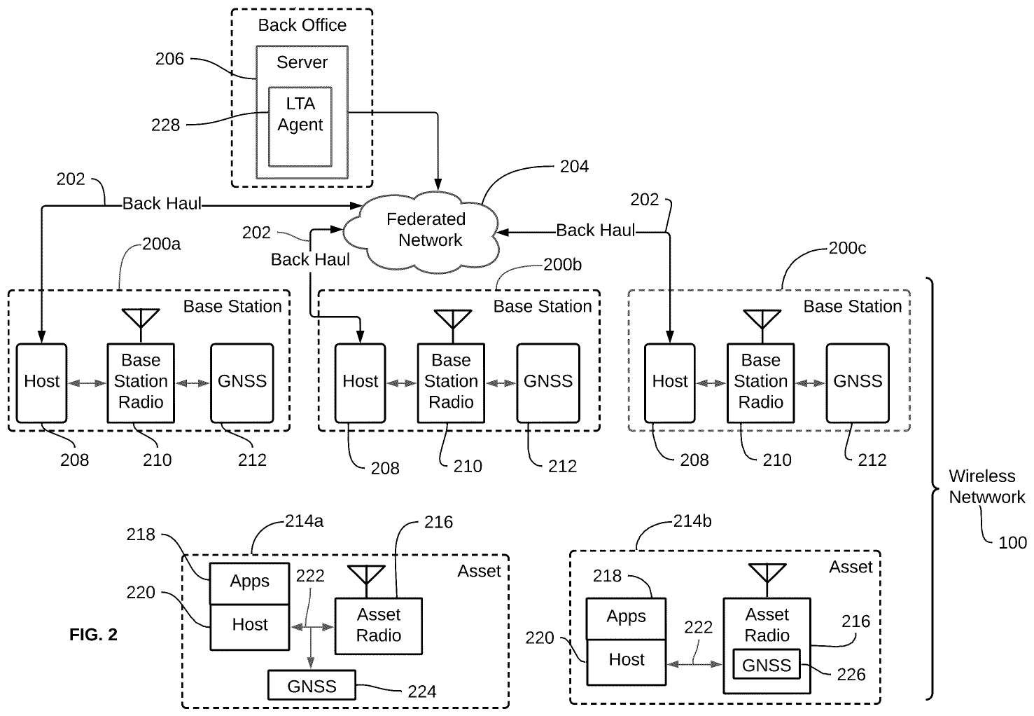

The schematic diagram in FIG. 2 represents the wireless train control network 100 with a plurality of base stations represented by base stations 200a, 200b, and 200c. In practice, a wireless train control network like ITCnet has many more than three base stations. These base stations are connected through different backhauls 202 to a federated network 204 that interconnects the base stations with one or more remote servers 206 that run programmed processes that enhance the resilience of the PNT determinations made by PNT-aware assets. The servers provide what will be referred to in the description as resilient PNT (RPNT) service to wireless train control networks and railroad assets that are PNT-aware. The servers may thus also be called RPNT servers. The services are, for example, located in one or more “back offices” of the railroad operators, the operators of the wireless train control network 100 and its base stations, operators of the railroad assets, or other service providers. The terms back office and server are not meant to be limited. A back-office may be any location control or under the control of the provider of the RPNT services provided by the server. The server may run on one or more hardware servers in a secure location or “in the cloud” using an infrastructure or platform as a service provider and thus could be hosted on one or more virtual servers, containers, or compute instances with appropriate levels of security. Multiple instances of the RPNT server may be used to support an interoperable train control network, including ITCnet.

The federated network represents a collection of interconnected networks that coordinate to provide secure transport of messages base stations and the one or more RPNT servers 206. Only one RPNT server 206 is illustrated. A federated network can support multiple geographically distributed servers that provide load distribution, redundancy, and backup.

The base stations 200a-200c in the diagrams are schematically illustrated and intended only to be representative of base stations in a wireless train control network. Each of these base stations have one or more host computers or processors 208 for handling various processes relating to routing messages transmitted and received by a base station radio 210. Each of these base stations also include a global navigation satellite system (GNSS) sensor 212 to determine time and position.

The schematic diagram of FIG. 2 also includes two representative, non-limiting examples of PNT-aware railroad assets 214a and 214b. Each asset includes an asset radio 216, a host 220 for running programmed processes, including protocol stacks enabling hosted railroad applications 218 to send and receive messages through the wireless train control network. The host and base radio are connected by a captive local area network (LAN) 222, which allows application processes on the host to route messages to and receive messages from the asset radio 216 that are transported by the wireless train control network 100. The wireless network supports and acts as a transport for an end-to-end messaging service for railroad application messages, an example of which is the ITCM (Interoperable Train Control Messaging) service used by ITCnet. The asset 214a has a captive GNSS sensor 224 that is not integrated into the asset radio 216. In this configuration, an application process on the host to obtain measurements from the sensor to make PNT determinations and to construct the payload of a PNT validation packet, which is described below, that is routed over the captive LAN 222 to the asset radio 216 for broadcast to base stations of the wireless train control network 100, examples of which are the base stations 200a-200c. Asset 214b has an asset radio 216 with an integrated GNSS sensor 226, which allows programmed processes stored as, for example, firmware in the asset radio to take measurements from the GNSS sensor and construct the payload for an RPNT packet.

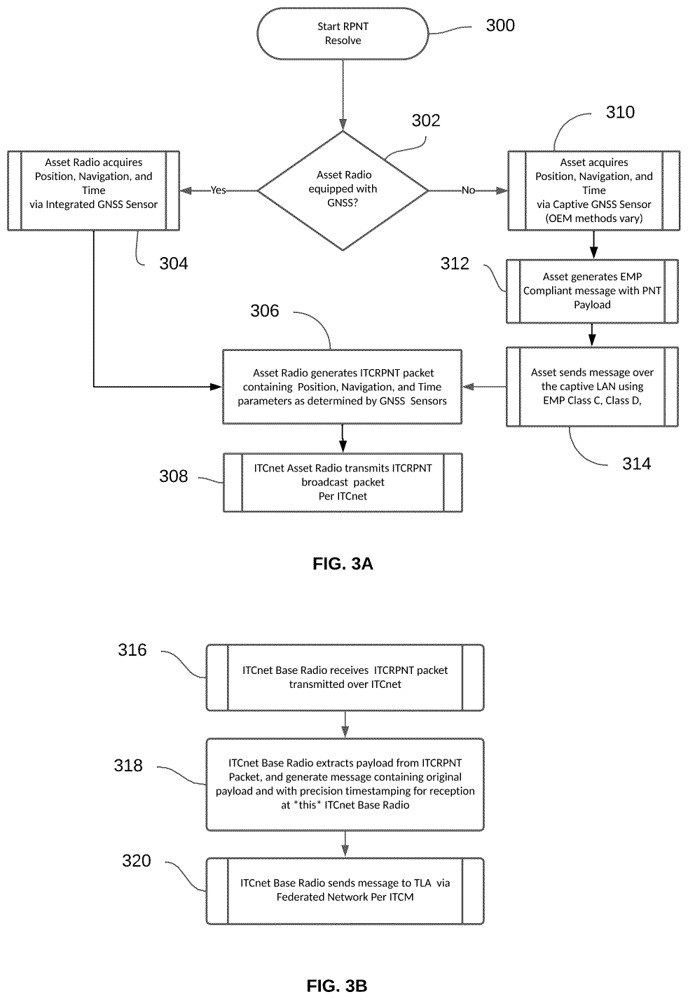

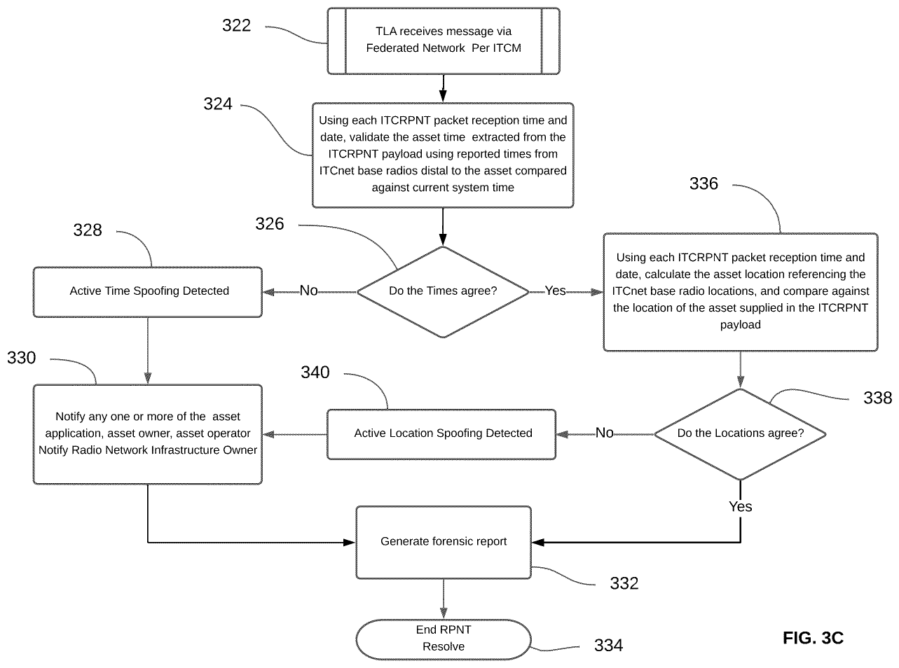

The flowchart of FIGS. 3A-3C illustrates the steps of a representative, nonlimiting example of an implementation of a process—referred to solely for purposes of reference herein as “RNPT Resolve”—to determine whether there is active spoofing by validating one or more of the time, location, and navigation determinations made by PNT-aware railroad assets. If any of them are incorrect, it may generate one or more notifications of a spoofing event. The representative examples shown in the FIGS. 3A-3C illustrates software or firmware implemented processes that occur at a PNT-aware railroad asset, such as asset 214a or 214b (FIG. 3A) a base station of a wireless train control network, such any one of base stations 200a-200c (FIG. 3B) and an RPNT server, such as the TLA agent 228 at the RPNT server 206 (FIG. 3C). Process 300 occurs in response to any one or more of a predefined triggering event or condition. It is preferred but not required that the RPNT process on the asset operates autonomously to initiate or cause an RPNT packet to be sent. Examples of triggering events include any one or more of the following events or conditions: generation of a periodic location report; a preset distance traveled; a predetermined speed and heading; and an expiration of a preset length of time since the last transmission of PNT validation packet; and any other conditions or events that may transpire and can be detected by a programmed process running on a railroad asset. Transmission of a PNT validation packet may also be triggered on-demand, such as by a polling message received from, for example, the RPNT server.

Referring to FIG. 3A, when the RPNT resolve process 300 is triggered at the asset, the asset generates an RPNT packet at step 306, which is then transmitted by the asset's radio at step 308 on a wireless train control network. The process of FIG. 3A may be implemented as a programmed application process on a host at the asset—an RPNT application—or as firmware in an asset radio, or by both. How the RPNT packet is generated depends on whether the GNSS sensor is integrated into the asset radio, as indicated by step 302. If the GNSS sensor is integrated into the asset radio, the asset radio acquires current time, position, and navigation information from the integrated GNSS sensor, as represented by step 304, and generates at step 306 the RPNT packet containing this information. Otherwise, the hosted application at the asset acquires the PNT information from a captive GNSS sensor at step 310. At step 312, the application generates a message containing as its payload the acquired PNT information in a predetermined format for routing over the local area network to the asset radio at step 314. The asset radio will, at step 306, insert the message into an RPNT packet for transmission at step 308. The RPNT packet may have a predefined format. It may also be transmitted according to predefined rates, with predefined modulation, coding, and error correction parameters that provide lower error rates and more reliable transmission and reception.

In a representative, non-limiting example of an RPNT packet, the payload of the packet contains, as a subset, the following data as understood by the asset's GNSS sensors: position (latitude, longitude, altitude); navigation (heading, speed); time (UTC date, UTC time). In alternative embodiments, only the time or the time, position information, or navigation information is acquired and transmitted.

For an ITCnet implementation, the message that contains PNT information at step 312 is, in a representative embodiment, an EMP compliant message, meaning that it complies with AAR (Association of American Railroads) S-9354 Edge Message Protocol (EMP) Specification that has the PNT information as a payload. EMP is an application-level protocol used by railroads that allows for interoperability using a message envelope for railroad applications to exchange data using multiple different message transport protocols, such as UDP, TCP, JMS, and AAR Standard S-9356 (Class D) protocols. At step 312, a communications process on the host encapsulates the message with an EMP envelope. A Class C or Class D AAR standard messaging protocol header is added to the EMP envelope before it is routed over the captive local area network using UDP/IP or TCP/IP headers from the network interfaces of the host and the asset radio. The messaging system of ITCnet uses Class C or D protocols in combination with UDP/IP and TPC/IP for interoperable network transport.

The RPNT packet in this example is a predefined packet type designated for RPNT services. However, the use of a packet type solely for RPNT services is optional and not required for the process. A packet type used only for RPNT services can enable more efficient or special handling of the packet by a base station radio. For example, it can be recognized and handled by a base station using predefined processes that process the packet differently from other packets. The predefined format, including specified lengths, may, optionally, also allow more efficient transmission with lower error rates and more efficient processing.

In the example of ITCnet, the ITCRPNT packet is a predefined type of broadcast packet in a common channel, in which all base station radios receive wireless packets. Broadcasted packets do not require acknowledgment when received. By using a broadcast type of packet, all base station radios within range can receive and process the packet without establishing a link or connection with the asset radio. Furthermore, the lengths of the preamble, header, payload, and CRC (Cyclic Redundancy Check) field are, preferably, predefined, and fixed and thus known by all base station radios that receive one. If HMAC is used, its length is also known.

Furthermore, by inverting a standard preamble that is prescribed for all wireless packets in an ITCnet network for ITCRPNT packets, firmware in the ITCnet radios can be programmed with a process for identifying ITCRPNT packets for precision timestamp processing, which is preferred but not necessarily required, for making time difference of arrival (TDOA) calculations, as it does not task the firmware with TDOA processing for every wireless packet. Furthermore, transmission rates and FEC (Forward Error Correction) type are, preferably but do not have to be, also predefined for ITCRPNT packets for the following reasons. Knowing the time of arrival of the start of a packet's preamble increases the precession of the measurement of the arrival time of the packet. A packet for ITCnet will typically include a preamble of explicit or a predefined length, a header, and a payload encoded using forward error correction (FEC), and a CRC. However, the preamble detection process of the receiving radio is usually not able to detect the entire preamble. An initial portion of the preamble packet is typically not detected and thus missing. By using a packet of a known, fixed length for TDOA determination, the TDOA process at a radio may, optionally, perform additional steps to infer the time of arrival of the start of the preamble. The TDOA process at the radio back calculates the time of arrival of the boundary between the preamble and the header of the packet. The known length of the header, payload, and CRC allows it to do this without having to detect and decode the contents of the packet. Knowing the length of the preamble, the TDOA determination process then calculates the time arrival of the start of the preamble based on the time of arrival of the boundary. Changing FEC and data rates used for encoding the payload will change the payload length and thus the packet length. Requiring that packet types used for TODA calculations use a predetermined FEC and data rate results in a fixed length packet, the length of which is known, allowing for the firmware processes in radios to be configured to calculate time of arrival timestamps for a packet based on the start of the preamble.

FIG. 3B illustrates the basic steps of an ITCnet base station for handling an ITCRPNT packet received by the base station radio at step 316. The process is a representative, not limiting example of an embodiment for processing RPNT packets at base stations of a wireless train control network. When the ITCRPNT packet is received by an ITCnet base radio, it extracts, as represented by step 318, the payload from RPNT Packet and generates a message containing the original payload, or, optionally, a portion of it and a timestamp of the time of reception of the packet at the ITCnet base radio. Each base station radio that receives an RPNT packet that is broadcast by a railroad asset will process the packet in a substantially similar way if the base station is programmed to process an RPNT packet the same way. The base station time stamps the packet with a measured arrival time.

In an embodiment of the process, a base station records the electromagnetic wavefront arrival time when the base station radio receives an RPNT validation packet, it. However, this requires phase matching. The wavefront arrival time allows for determining the location of the railroad assets more precisely. However, it is possible to detect spoofing, at least in some if not most or all circumstances, with sufficient confidence if a less precise location is used. Furthermore, not calculating the location railroad asset with such a high degree of precision will simplify the RPNT validation process used by the RPNT server, an example of which is illustrated by FIG. 3C. The base radio may use packet component detection time instead of, or in addition to, wavefront arrival time.

As part of the process represented by step 318, a process programmed into the base station radio or another processor at the base station appends to the payload of the packet its arrival time at the base station as measured by the base station, and GNSS information measured by the base station from its GNSS sensor to form a message that will be routed to the TLA agent 228 running on the RPNT server 206. The GNSS information includes at least the location or position of the base. It may also include identification of the satellites used by the base to determine its position and time, the HDOP (horizontal dilution of precision), and other GNSS-related information. As represented by step 320, the base station then routes the message to the TLA agent 228 through, for example, the federated network 204. In an ITCnet implementation, the message is transported over the federated using ITCM and related protocols to an ITCM gateway (not shown) associated with the RTPN server.

Each base station radio that receives that RPNT packet broadcast by the railroad asset at step 308 and sends an RPNT message to the RPNT server is considered a “participating base station” for purposes of the RPNT process.

Please refer now to FIG. 3C. Once the TLA agent receives the message sent at step 322 from each participating base station, the TLA performs one or more validation processes. The arrival times at the base stations of the RPNT packet received from an asset radio are used as a basis of calculations made during the validation processes to determine the actual location and time for the asset. In one validation process, the TLA uses data received from all base station radios to calculate a location of an asset. In this example, it uses TODA.

At step 324, the TLA may, optionally, first validate the times being reported by participating base station radios and assets. In the time validation process, the TLA requests UTC Time from GNSS sensors at several far-away base locations, for example, non-participating base stations 110. Using far-way base stations helps to ensure that the returned UTC time is out of range of any spoofing equipment that could have affected the location and time measured by the asset. The returned UTC times are compared to ensure that they agree. If they agree, the returned time is used as the current system time and as a reference time for the time validating process. The reference time is compared one or more of the following: the asset's time when RPNT packet is transmitted, which is included in the RPNT packet, the time of arrival for the RPNT packet that is included in the RPNT message from the base station, the base station time when the RPNT message is sent, which is also included in the RPNT message. As represented by steps 326 and 328, if there are mismatches or differences exceeding configurable periods and precision—such as seconds, minutes, or hours—the base station times in the RPNT messages and the reference time, the RPNT packet time of arrival timestamps and the asset time, and/or between the reference time and the other times in the RPNT message, the process generates an alert to announce a spoofing event with high confidence.

In the event of a spoofing alert, the process sends or causes to be sent at step 330 a notification of spoofing in a message routed to the RPNT application at the asset. The message is transported by the train control network to the asset in the manner that other application messages are routed to the asset. It may also, or instead, send one or more messages with the alert to any one or more of the following: the owner of the asset, the operator of the asset, and the operators of the base radio stations via the federated network. The process then may, optionally, generate a forensic report at step 332. The resolve process 300 then ends at step 334.

If the comparison of the times at step 326 does not result in a difference that exceeds the threshold or other condition for triggering detection of time spoofing, the process continues at step 336. Using data from a cluster of base stations radios receiving the same RPNT packet, the TLA validation process uses the reception time or timestamp of the packet at each participating base station and the locations of the base radio stations to calculate the location of the asset. In one embodiment, this calculation is made according to established TDOA formulae.

The TLA may, optionally, weight the final calculation of the asset location using GNSS information included in each base station's RPNT message. This information may include, for example, the number of satellites used at each participating base station and, optionally, HDOP if provided. If more precise Location determination is needed, permutating the calculation process can be executed. This calculated asset location is then compared to the location reported by the asset in the RPNT packet payload received by each base station. If there is a mismatch that exceeds a configurable accuracy and precision (for example, a certain number of feet, meters, kilometers, or miles), the process determines that active location spoofing has been detected with high confidence, as represented by step 340. The process then notifies at step 330 and generates an optional forensic report at step 332 before ending. If no location spoofing is detected, the process generates a forensic report at step 332 and ends at step 334.

The TLA residing on the RPNT server may, optionally, make use of certain input artifacts when performing the validation tasks. Examples artifacts that the RPNT server may make use of include the ITCnet Track ICD used for IPM for location disambiguation visa vi snap to track point, and notices relating the GNSS—for example, GNSS NOTAMs—for areas affected by outages. “ICD” refers to an Interface Control Document, which is an artifact containing a collection of input data describing specific locations and track points at those locations. It is used by, for example, a software program from Meteorcomm LLC called the ITCnet Planning Module (ITP) for planning parts of the ITCnet radio network responsible for conveying Wayside Status Messages. A Track Point ICD contains machine-readable information for use in determining radio coverage at a given and specific location. It acts like a map.

During location determination activities, either through GNSS or through radio TDOA, the TLA may use the Trackpoint ICD can be used to resolve any ambiguity in the position of a train that arises due to the uncertainty associated with a resolved radius of the position of the train. Trains must normally be on a track. Thus, any ambiguities as to the location of a train within a radius of uncertainty associated with resolving the position of a train using the radio TDOA can be, unless the train has de-railed, resolved using the nearest point on a track on which the train has authority to move.

For example, a spoofed location might cause the onboard GNSS system to resolve its location is outside of its movement authority—i.e., where on the railroad's tracks it is permitted to be. This would cause the train to be stopped by PTC automatic enforcement and trigger the train management computer to report a position several miles away from where it is. Due to the train reporting its incorrect position, technical and special agent response resources will be dispatched to the wrong location, leaving the train and its contents vulnerable to tampering and theft.

Apparatus and systems such as those described above would, for example, determine a location using the radio infrastructure independently of the GNSS-determined location reported by the train. Once the GNSS resolved location reported by the train is compared by the TLA or a subordinate entity, a disagreement will generate an alert of possible location spoofing, prompting investigation to determine the actual train location.

The methods described above may, optionally, be further enhanced by comparing the location or series of locations of a train resolved using the radio infrastructure as described above with expected track points along the route of the train within an area that the train is authorized to move and the last known heading and speed variations of the train.

The resolution of the location as determined using the radio infrastructure in any of the preceding methods may, optionally, be further enhanced using a “snap-to process.” The TLA, or subordinate entity would, in this embodiment, generate a virtual map for a snap-to process that can be used to resolve a potential ambiguous location with improved accuracy optionally. The snap-to process converts a location resolved by the GNSS that is not on a track to the nearest point that is on the track.

Optionally, the TLA process may perform a process to validate navigation information determined by the asset and included in the RPNT packet. For example, the validation of the navigation information may take place after step 338 or the end of the RPNT resolve process if no location spoofing is detected.

In the process of validating the navigation information, the TLA or RPNT polls or sends a message requesting, or initiates a process of polling or requesting, that the asset send a second RPNT packet. The location validation process represented by steps 336 and 338 is repeated to determine the actual location of the asset when the second RPNT packet is sent. The navigation validation process then compares the speed and heading parameters in payload with calculated speed and heading determined through interpolation of location changes between first and second RPNT packets over the elapsed time between the creation times of first and second RPNT packets as reported in the RPNT packets. The process determines that a spoofing event has been detected with high confidence if there is a mismatch been the speed and heading reported by the asset and the calculated speed and heading that exceeds one or more configurable thresholds for accuracy and precision. The one or more thresholds may consider speed and heading variances. It then generates notification messages as described in connection with step 330 and generates a forensic report at step 332 before ending at step 334.

The processes and process steps described herein as being performed by a server or computer or computer system, or as “computer implemented,” are implemented by a processor—part of a computer or computing machine or system—executing software stored in memory accessible by the processor. Software reefers to programs of instructions or code stored in memory, which can be directly or indirectly (after any needed compilation, interpretation, and loading into memory) executed by one or more processors. A processor can be a microprocessor, microcontroller, or central processing unit, or a specialized processor. Examples of specialized processors include a graphics processing units, various types of co-processors, digital signal processor (DSP), and the like. The processes, such as those implemented on an asset radio, may also be implemented in whole or in part using programmable hardware, such as field-programmable gate arrays (FPGA), hardware, such as application-specific integrated circuits (ASIC), or combinations of the various types of hardware (processors, FPGA, ASICS) and software. For the avoidance of doubt, software includes “firmware” and instructions or descriptions and configurations for configuring programmable hardware. Also, for the avoidance of doubt, “computer” or “computer system” includes embedded systems and programmable and configurable hardware.

Software is stored or transmitted in a computer readable medium. Representative, nonlimiting examples of computer-readable media include non-transitory storage media and communication media including any medium that facilitates transfer of a computer program from one place to another. By way of example, and not limitation, non-transitory computer-readable media may comprise random-access memory (RAM), read-only memory (ROM), electrically erasable programmable read only memory (EEPROM), flash memory, optical disk storage, magnetic disk storage or other magnetic storage devices, or any other non-transitory medium that can be used to carry or store program code means in the form of instructions or data structures that can be read by a computing system for execution directly or indirectly by a processor or programmable hardware. Combinations of the above are also included within the scope of computer-readable media.

The preceding description is of non-limiting representative embodiments and examples. The invention, as defined by the appended claims, is not limited to the described embodiments. Alterations and modifications to the disclosed embodiments may be made without departing from the invention. The meaning of these terms used in this specification is, unless stated otherwise, intended to have their ordinary and customary meaning to those in the art and are not intended to be limited to specific implementations that may be described. The term “comprising” means including but not limited to. Phrases such as “in one embodiment,” “according to one embodiment,” and the like generally mean that the described feature, structure, or characteristic is optional for other embodiments but may be included in any of the embodiments even if it is not expressly stated. If the specification describes something as “exemplary” or an “example,” it is a non-exclusive example.

What is claimed is:

1. A method executed by one or more programmed processes at one or more computers in communication with base stations comprising a wireless train control network to detect spoofing attacks on position, navigation, and time (PNT) systems used by the wireless train control network, the plurality of base stations having base radios configured for wireless transport of messages between railroad applications and asset radios on remote mobile railroad assets, the method comprising a position validation process that comprises:
receiving a resilient PNT (RPNT) message from each of a plurality of participating base stations that received a wireless packet transmitted by an asset radio of a railroad asset and containing PNT information, the PNT information transmitted by the asset radio being determined by the railroad asset using one or more captive satellite navigation system sensors and comprises a position of the railroad asset and each RPNT message containing a timestamp for a time of arrival of the wireless packet at the participating base station and the PNT information contained in the wireless packet;
determining a calculated asset position based on the time of arrival of the wireless packet at each of the plurality of base stations;
comparing the calculated asset position to the asset position included in the PNT information in the wireless packet transmitted by the asset radio; and
generating a notice of spoofing if the calculated asset position and asset position reported by the asset in the wireless packet differ by an amount that exceeds one or more predetermined thresholds and otherwise not generating the notice of spoofing.

2. The method of claim 1, wherein:
the PNT information in the wireless packet from the asset radio includes a transmission time of the wireless packet that is determined by the railroad asset or the asset radio;
each RPNT message includes a time of transmission of the RPNT message by the participating base station radio;
the method further comprises a time validation process, the time validation process comprising:
determining one or more time differences between any one or more of the following: base station times in the RPNT messages and a reference time; timestamp for the time of arrival of the wireless message from the railroad asset at any two or more of the plurality of participating base stations; a time of arrival for any of the RPNT messages and the transmission time of the wireless packet; the time of arrival for any of the RPNT messages and any time contained in RPNT message; the transmission times of the RPNT message by any two or more of the plurality of participating base stations; the transmission times of the RPNT message from any two or more of the plurality of participating base stations and any other time contained in the RPNT messages from any two or more of the plurality of participating base stations; and
determining whether any of the one or more time differences exceed one or more predetermined thresholds; and
generating the notice of spoofing comprises generating the notice of spoofing if the calculated asset position and asset position reported by the asset in the wireless packet differ by an amount that exceeds one or more predetermined thresholds or any of the one or more time differences exceed any of the one or more predetermined thresholds, generating the notice of spoofing time spoofing alert and otherwise not generating the notice of.

3. The method of claim 2, wherein the time validation process is performed prior to the position validation process.

4. The method of claim 2, further comprising requesting a current time from a plurality of non-participating base stations and using times returned by the non-participating base stations to determine a reference time.

5. The method of claim 1 wherein the notice of spoofing is sent electronically to one or more of the following: the railroad asset, an operator of the railroad asset, an owner of the asset, and any one or more operators of any one or more of the plurality of participating base stations.

6. The method of claim 1, wherein:
the wireless packet is a first wireless packet transmitted by the asset radio, the first wireless packet including position, heading and speed information as determined by the asset from its captive GNSS sensor at the time the first wireless packet is transmitted;
the asset radio subsequently transmits a second wireless packet containing PNT information determined by the asset using the one or more captive satellite navigation system sensors, the second wireless packet including position, heading and speed information as determined by the asset from its captive GNSS sensor at the time the second wireless packet is transmitted;
the RPNT message from each of the plurality of participating base stations is a first RPNT message and two or more of the plurality of base stations subsequently send a second RPNT message in response to receiving the second wireless packet; and
the method further comprises performing a navigation validation process, the navigation validation process comprising:
calculating an actual asset position based on the time of arrival of the second wireless packet at each of the two or more of the plurality participating base stations that send the second RPNT message;
comparing the speed and heading of the railroad asset in the second RPNT message through interpolation of change of calculated railroad asset locations between first and second RPNT packets over an elapsed time determined from a creation time contained in each of the first and second RPNT messages; and
generating the notice of spoofing when there is a mismatch between speed and heading reported by the asset in the second wireless packet and the calculated speed and heading that exceeds a predetermined difference.

7. In a wireless train control network radios for wireless transport of messages for railroad applications to and from asset radios of remote railroad assets and base stations, a method for use in detecting detect attacks on position, navigation, and time (PNT) systems used by the wireless train control network, comprising:
receiving at a base station radio a wireless packeted transmitted by an asset radio of a remote mobile railroad asset, the wireless packet containing PNT determined by the railroad asset using one or more satellite navigation system sensors at the remote railroad asset, the PNT information indicative of any one or more of the railroad asset's position, heading, speed, and time; and
in response to receiving the wireless packet, sending a message to a predetermined server process for detecting spoofing attacks on PNT systems used by the wireless network, message containing a timestamp for the time of arrival of the wireless packet at the base station radio and the PNT information from the wireless packet.

8. The method of claim 7, wherein the base station radio inserts in the message a time of transmission of the message by the base station radio.

9. The method of claim 7 wherein:
the wireless packet is a first wireless packet transmitted by the asset radio and the message sent by the base stations is a first message;
the method further comprises:
receiving at the base station radio a transmission by the asset radio of a second wireless containing PNT information determined by the asset using the one or more captive satellite navigation system sensors, wherein the first wireless packet includes position, heading and speed information as determined by the asset from its GNSS sensor at the time the first packet is transmitted, and the second packet including position, heading and speed information as determined by the asset from its GNSS sensor at the time the second packet is transmitted; and
sending with the base station a second message to the server process in response to receiving the second wireless packet at the base station.

10. A method implemented by computer for use in detecting detect attacks on position, navigation, and time (PNT) systems on railroad assets by a wireless train control network, comprising:
generating in response to a trigger a message containing information representing at least one PNT parameter obtained from at least one GNSS sensor at the railroad asset, the message having an application-level protocol header for exchanging data between railroad applications that allows for multiple different message transport protocol;
transmitting with the radio a wireless packet containing the message to at least one base station of the wireless train control network.

11. The method according to claim 10, wherein the message encapsulated with an envelope that complies with AAR (Association of American Railroads) S-9354 Edge Message Protocol (EMP), the header being part of an EMP envelop.

12. The method according to claim 10 wherein the GNSS sensor is integrated with the radio, the radio being configured to obtain the at least one PNT parameter from the integrated GNSS sensor and to generate the packet.

13. The method according to claim 10, wherein the GNSS sensor is a captive GNSS sensor, and the method further comprises obtaining the at least one PNT parameter from the captive GNSS sensor, generating the message containing at least one PNT parameter, and routing the message to the radio over a local network at the railroad asset.

14. The method according to claim 13, wherein the message is encapsulated in an envelope that complies with AAR (Association of American Railroads) S-9354 Edge Message Protocol (EMP), and wherein the method further comprises adding a Class C or Class D AAR standard messaging protocol header to the EMP envelope before it is routed over the captive local area network to a network interface of the radio using UDP/IP or TCP/IP headers.

15. The method according to claim 10, wherein the wireless packet is a predefined packet type for transmitting PNT information, and wherein transmitting the wireless packet comprises transmitting the wireless packet a predetermined data rate, with predefined modulation, coding, and error correction parameters, based on the predefined packet type for transmitting PNT information.

16. The method according to claim 10, wherein the message contains the following PNT information as understood by the asset's GNSS sensor: position (latitude, longitude, altitude), navigation (heading, speed), and time (UTC date, UTC time).
